(19) United States
(12) Patent Application Publication
(10) Pub. No.: US 2020/0309814 A1
(43) Pub. Date: Oct. 1, 2020

(54) INERTIAL SENSOR, ELECTRONIC DEVICE, AND VEHICLE

(71) Applicant: SEIKO EPSON CORPORATION, Tokyo (JP)

(72) Inventors: Teruo TAKIZAWA, Matsumoto-shi (JP); Satoru TANAKA, Chino-shi (JP); Shinichi KAMISUKI, Shiojiri-shi (JP)

(21) Appl. No.: 16/831,193

(22) Filed: Mar. 26, 2020

(30) Foreign Application Priority Data
Mar. 27, 2019 (JP) 2019-060671

(51) Int. Cl. G01P 15/125; G01C 21/12

(52) U.S. Cl. CPC G01P 15/125; G01S 19/47; G01C 21/12

(57) ABSTRACT

An inertial sensor includes: a substrate; a movable body swung around a swing axis with respect to the substrate; a detection electrode that is provided at the substrate and that overlaps with the movable body in a plan view; a dummy electrode that is provided on the substrate, that overlaps with the movable body in the plan view, and that has the same potential as that of the movable body; and a protrusion that is provided on the substrate, that overlaps with the first movable portion in the plan view, that protrudes toward the movable body, and that prevents the movable body from being displaced around the swing axis, in which the dummy electrode is located between the protrusion and the detection electrode, and surrounds at least a part of a periphery of the protrusion, and a contact portion of the protrusion with the movable body is formed of an insulating material.

The present application is based on, and claims priority from JP Application Serial Number 2019-060671, filed Mar. 27, 2019, the disclosure of which is hereby incorporated by reference herein in its entirety.

### BACKGROUND

### 1. Technical Field

The present disclosure relates to an inertial sensor, an electronic device, and a vehicle.

### 2. Related Art

For example, the inertial sensor disclosed in JP-A-2017-146312 includes a movable body that is swung in a seesaw manner around a swing axis, and a first detection electrode and a second detection electrode that are provided directly below the movable body.

In the inertial sensor, when acceleration in a Z axis direction is applied, the movable body is swung in the seesaw manner around the swing axis. Accordingly, electrostatic capacitance between the movable body and the first detection electrode and electrostatic capacitance between the movable body and the second detection electrode are displaced in opposite phases. Therefore, the acceleration in the Z axis direction may be detected based on an amount of change in electrostatic capacitance.

A protrusion is formed at each of the first detection electrode and the second detection electrode, and further displacement of the movable body is prevented by bringing the movable body into contact with the protrusion.

However, in the inertial sensor in JP-A-2017-146312, the detection electrodes surround a periphery of the protrusion, and a potential difference is generated between the movable body and the detection electrodes. In this case, when the movable body sticks to the protrusion, the sticking may be difficult to be released due to electrostatic attraction caused by the potential difference between the movable body and the detection electrodes.

### SUMMARY

An inertial sensor according to an embodiment includes: a substrate; a movable body that includes a first movable portion and a second movable portion sandwiching a swing axis and having different rotation moments around the swing axis and that is swung around the swing axis with respect to the substrate; a detection electrode that is provided at the substrate and that overlaps with the first movable portion in a plan view; a dummy electrode that is provided on the substrate, that overlaps with the first movable portion in the plan view, and that has the same potential as that of the movable body; and a protrusion that is provided on the substrate, that overlaps with the first movable portion in the plan view, that protrudes toward the movable body, and that prevents the movable body from being displaced around the swing axis, in which the dummy electrode is located between the protrusion and the detection electrode and surrounds at least a part of a periphery of the protrusion, and a contact portion of the protrusion with the movable body is formed of an insulating material.

### BRIEF DESCRIPTION OF THE DRAWINGS

FIG. 1 is a plan view illustrating an inertial sensor according to a first embodiment.

FIG. 2 is a cross-sectional view taken along a line A-A in FIG. 1.

FIG. 3 is a cross-sectional view taken along a line B-B in FIG. 1.

FIG. 4 is a cross-sectional view taken along a line C-C in FIG. 1.

FIG. 5 is a plan view of the inertial sensor in FIG. 1.

FIG. 6 is a plan view illustrating a modification of the inertial sensor in FIG. 1.

FIG. 7 is a cross-sectional view illustrating an inertial sensor according to a second embodiment.

FIG. 8 is a cross-sectional view illustrating the inertial sensor according to the second embodiment.

FIG. 9 is a cross-sectional view illustrating an inertial sensor according to a third embodiment.

FIG. 10 is a cross-sectional view illustrating the inertial sensor according to the third embodiment.

FIG. 11 is a cross-sectional view illustrating an inertial sensor according to a fourth embodiment.

FIG. 12 is a cross-sectional view illustrating the inertial sensor according to the fourth embodiment.

FIG. 13 is a plan view illustrating an inertial sensor according to a fifth embodiment.

FIG. 14 is a plan view illustrating a smartphone according to a sixth embodiment.

FIG. 15 is an exploded perspective view illustrating an inertial measurement device according to a seventh embodiment.

FIG. 16 is a perspective view of a substrate provided in the inertial measurement device illustrated in FIG. 15.

FIG. 17 is a block diagram showing an entire system of a vehicle positioning device according to an eighth embodiment.

FIG. 18 illustrates operation of the vehicle positioning device shown in FIG. 17.

FIG. 19 is a perspective view illustrating a vehicle according to a ninth embodiment.

### DESCRIPTION OF EXEMPLARY EMBODIMENTS

Hereinafter, an inertial sensor, an electronic device, and a vehicle according to the present disclosure will be described in detail based on embodiments shown in the accompanying drawings.

### First Embodiment

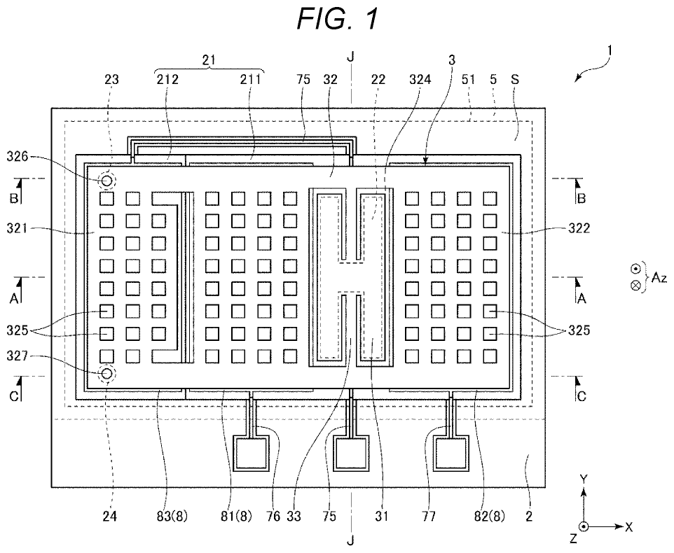

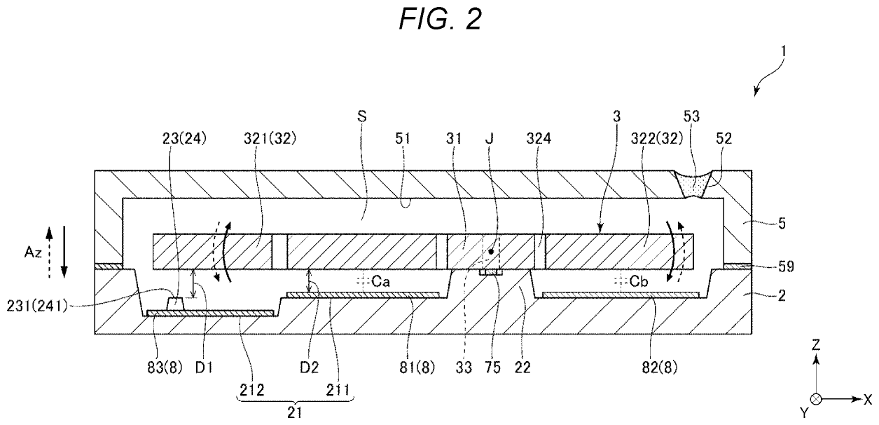

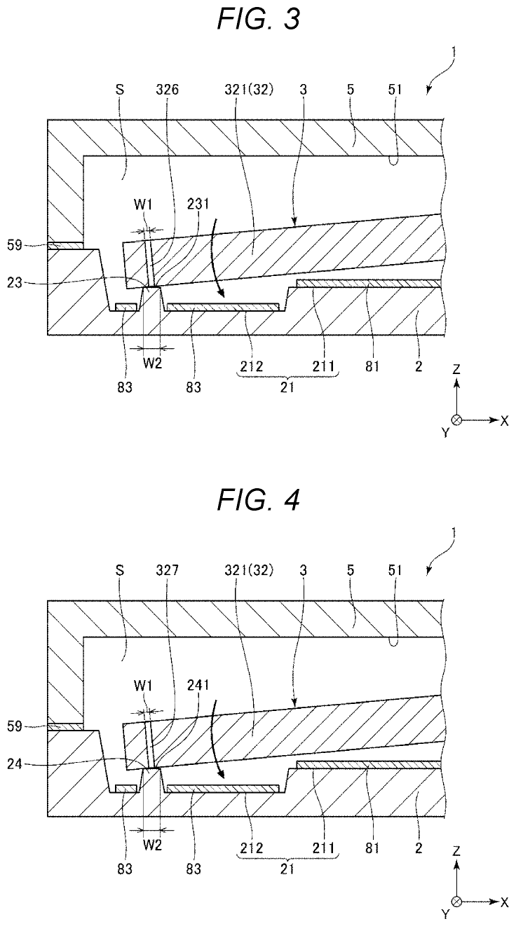

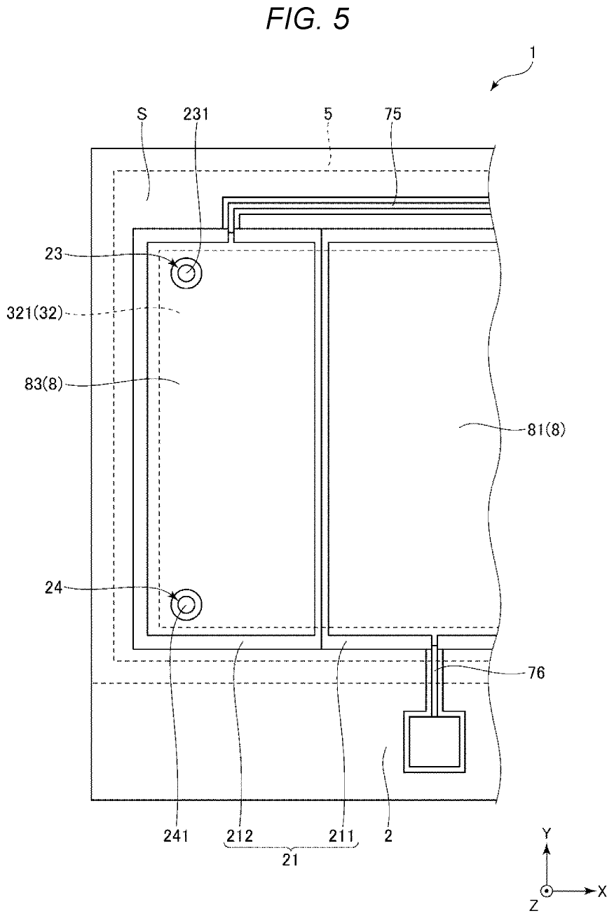

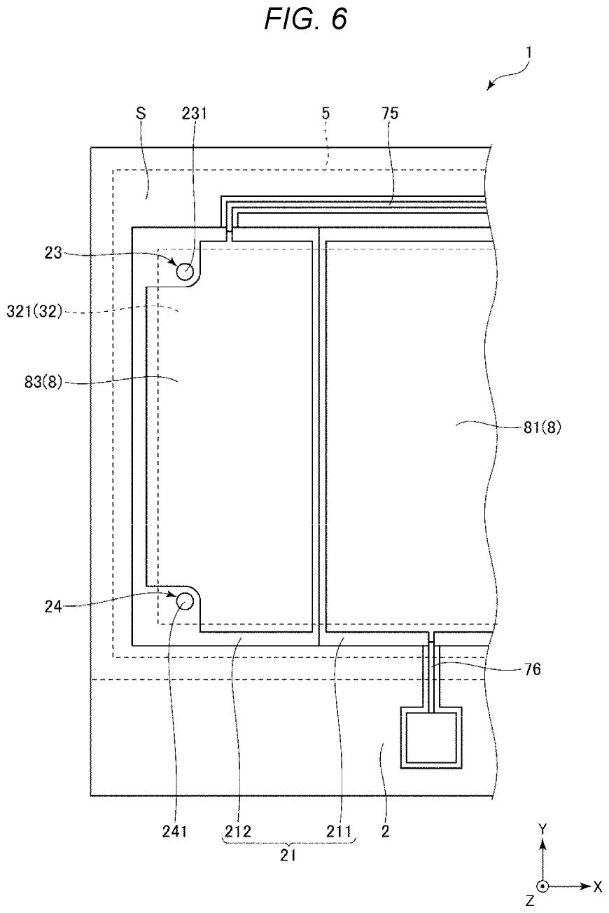

FIG. 1 is a plan view illustrating an inertial sensor according to the first embodiment. FIG. 2 is a cross-sectional view taken along a line A-A in FIG. 1. FIG. 3 is a cross-sectional view taken along a line B-B in FIG. 1. FIG. 4 is a cross-sectional view taken along a line C-C in FIG. 1. FIG. 5 is a plan view of the inertial sensor in FIG. 1. FIG. 6 is a plan view illustrating a modification of the inertial sensor in FIG. 1. Hereinafter, three axes orthogonal to one another are referred to as an X axis, a Y axis, and a Z axis. A direction parallel to the X axis is also referred to as an “X axis direction”, a direction parallel to the Y axis is also referred to as a “Y axis direction”, and a direction parallel to the Z axis is also referred to as a “Z axis direction”. An arrow tip end side of each axis is also referred to as a “positive side”, and an opposite side thereof is also referred to as a “negative side”. The positive side in the Z axis direction is also referred to as “upper”, and the negative side in the Z axis direction is also referred to as “lower”. A plan view as viewed from the Z axis direction is also simply referred to as a “plan view”.

The inertial sensor 1 illustrated in FIGS. 1 and 2 is capable of detecting an acceleration Az in the Z axis direction. The inertial sensor 1 includes a substrate 2, a sensor element 3 provided at an upper side of the substrate 2, and a lid 5 that covers the sensor element 3 and is bonded to an upper surface of the substrate 2.

The substrate 2 includes a recessed portion 21 that opens to the upper surface thereof. The recessed portion 21 is formed larger than the sensor element 3 so as to contain the sensor element 3 in the plan view. The recessed portion 21 includes a first recessed portion 211 that opens to the upper surface of the substrate 2, and a second recessed portion 212 that opens to a bottom surface of the first recessed portion 211. The second recessed portion 212 opens at an end portion of the first recessed portion 211 at the negative side with respect to the first recessed portion 211 in the X axis direction. In other words, the recessed portion 21 includes the first recessed portion 211 having a first depth and a second recessed portion 212 having a second depth deeper than the first depth. The second recessed portion 212 is located at the negative side with respect to the first recessed portion 211 in the X axis direction.

The substrate 2 includes a mount 22 protruding upward from the bottom surface of the first recessed portion 211. The sensor element 3 is bonded to an upper surface of the mount 22. The substrate 2 includes two protrusions 23, 24 protruding upward from a bottom surface of the second recessed portion 212. That is, the protrusions 23, 24 are integral with the substrate 2. The protrusions 23, 24 overlap with a movable body 32 (described below) of the sensor element 3 in the plan view. These protrusions 23, 24 function as stoppers that, when the movable body 32 is excessively displaced, that is, when the movable body 32 is excessively swung, contact the movable body 32 and prevent further displacement of the movable body 32. When the swinging of the movable body 32 is stopped or in an appropriate range, the movable body 32 does not contact the protrusions 23, 24. The protrusions 23, 24 will be described in detail below.

An electrode 8 is provided at the substrate 2. The electrode 8 includes a first detection electrode 81 and a second detection electrode 82 that are provided at the bottom surface of the first recessed portion 211, and a dummy electrode 83 provided at the bottom surface of the second recessed portion 212. The substrate 2 includes groove portions that open to the upper surface thereof, and wires 75, 76, 77 are provided in the groove portions. The wire 75 is electrically coupled to the sensor element 3 and the dummy electrode 83, the wire 76 is electrically coupled to the first detection electrode 81, and the wire 77 is electrically coupled to the second detection electrode 82. One end portion of each of the wires 75, 76, 77 is exposed outside a lid 5 and functions as an electrode pad to perform electrical coupling with an external device.

Forming materials of the substrate 2 may include glass materials containing an alkali metal ion which is a movable ion such as Na⁺. The glass materials may include borosilicate glass such as Pyrex glass and Tempax glass (both are registered trademarks). Accordingly, the substrate 2 is formed of a glass material, so that the substrate 2 may be easily processed. A silicon substrate which is a base material of the sensor element 3 may be bonded to the substrate 2 by anodic bonding, so that the sensor element 3 may be easily formed. The transparent substrate 2 is obtained, so that an inside of a housing space S may be visually recognized through the substrate 2. However, the forming material of the substrate 2 is not particularly limited, and may be, for example, silicon, crystal, quartz, or the like.

The lid 5 includes a recessed portion 51 that opens to a lower surface thereof. The lid 5 is bonded to the upper surface of the substrate 2 so as to house the sensor element 3 in the recessed portion 51. The housing space S is formed inside the cover 5 and the substrate 2 to house the sensor element 3. As illustrated in FIG. 2, the lid 5 includes a through hole 52 that communicates the inside and an outside of the housing space S, and the through hole 52 is sealed by a sealing member 53. An atmosphere of the housing space S can be replaced with a desired atmosphere via the through hole 52. The housing space S is an airtight space in which an inert gas such as nitrogen, helium, or argon is sealed, and may be approximately at atmospheric pressure and at a use temperature which is, for example, approximately −40° C. to 125° C. However, the atmosphere of the housing space S is not particularly limited, and may be, for example, a depressurized state or a pressurized state.

A forming material of the lid 5 may be, for example, silicon. However, the forming material of the lid 5 is not particularly limited, and may be, for example, a glass material, crystal, quartz, or the like. Methods of bonding the substrate 2 and the lid 5 are not particularly limited, and may be appropriately selected depending on the materials of the substrate 2 and the lid 5. The methods include anodic bonding, activation bonding of bonding bonding surfaces activated by plasma irradiation, bonding with a bonding material which is glass frit or the like, metal eutectic bonding of bonding metal films formed at the upper surface of the substrate 2 and a lower surface of the lid 5, and the like. In the present embodiment, the substrate 2 and the lid 5 are bonded via a bonding member 59 formed over an entire periphery of the lower surface of the lid 5. For example, a glass frit material which is a low melting point glass may be used as the bonding member 59.

The sensor element 3 is formed by, for example, patterning a conductive silicon substrate doped with an impurity which is phosphorus (P), boron (B), arsenic (As), or the like by dry etching, and particularly, by a Bosch process. The sensor element 3 includes a fixed portion 31 anodically bonded to the upper surface of the mount 22, the movable body 32 displaceable relative to the fixed portion 31, and a beam 33 connecting the fixed portion 31 and the movable body 32. The method of bonding the mount 22 and the fixed portion 31 is not limited to anodic bonding.

When the acceleration Az acts on the sensor element 3, the movable body 32 is swung in a seesaw manner around a swing axis J formed by the beam 33 relative to the substrate 2 while the beam 33 is torsionally deformed. The movable body 32 has a longitudinal shape whose longitudinal direction is the X axis direction in the plan view. The movable body 32 includes a first movable portion 321 and a second movable portion 322 that sandwich the swing axis J in the plan view. The first movable portion 321 is located at the negative side with respect to the swing axis J in the X axis direction, and the second movable portion 322 is located at the positive side with respect to the swing axis J in the X axis direction. The first movable portion 321 is longer than the second movable portion 322 in the X axis direction, and a rotation moment of the first movable portion 321 around the swing axis J when the acceleration Az is applied is larger than that of the second movable portion 322.

The movable body 32 is swung in the seesaw manner around the swing axis J when the acceleration Az is applied due to the difference in the rotation moments. Swinging in the seesaw manner means that the movable body 32 is swung such that the second movable portion 322 is displaced to the negative side in the Z axis direction when the first movable portion 321 is displaced to the positive side in the Z axis direction, and on the contrary, the second movable portion 322 is displaced to the positive side in the Z axis direction when the first movable portion 321 is displaced to the negative side in the Z axis direction.

The movable body 32 is formed with a plurality of damping holes 325 penetrating the movable body 32 in a thickness direction thereof. The plurality of damping holes 325 are uniformly arranged over an entire region of the first movable portion 321 and the second movable portion 322. In particular, in the present embodiment, the plurality of damping holes 325 are arranged in a matrix aligned in the X axis direction and the Y axis direction. The plurality of damping holes 325 each have a square cross-sectional shape, and have the same shapes and sizes as one another.

The movable body 32 is formed with a through hole 324 located between the first movable portion 321 and the second movable portion 322. The fixed portion 31 and the beam 33 are provided in the through hole 324. With this configuration, a size of the sensor element 3 may be reduced. However, the arrangement of the fixed portion 31 and the beam 33 is not particularly limited, and may be, for example, outside the movable body 32 as in an embodiment described below.

Here, the electrode 8 provided at the recessed portion 21 will be described. As illustrated in FIGS. 1 and 2, the first detection electrode 81 faces a proximal end portion of the first movable portion 321, the second detection electrode 82 faces the second movable portion 322, and the dummy electrode 83 faces a distal end portion of the first movable portion 321. In other words, in the plan view from the Z axis direction, the first detection electrode 81 overlaps with the proximal end portion of the first movable portion 321, the second detection electrode 82 overlaps with the second movable portion 322, and the dummy electrode 83 overlaps with the distal end portion of the first movable portion 321.

When the inertial sensor 1 is driven, a drive voltage is applied to the sensor element 3 via the wire 75, and the first detection electrode 81 and the second detection electrode 82 are coupled to a charge amplifier via the wires 76, 77. Accordingly, an electrostatic capacitance Ca is formed between the first movable portion 321 and the first detection electrode 81, and an electrostatic capacitance Cb is formed between the second movable portion 322 and the second detection electrode 82. When the acceleration Az is applied to the inertial sensor 1 and the movable body 32 is swung in the seesaw manner, a gap between the first movable portion 321 and the first detection electrode 81 and a gap between the second movable portion 322 and the second detection electrode 82 change in opposite phases, and accordingly, the electrostatic capacitances Ca, Cb change in opposite phases. Therefore, the acceleration Az may be detected based on the changes in the electrostatic capacitances Ca, Cb.

The dummy electrode 83 not used for the detection of the acceleration Az has the following function. For example, if a surface of the substrate 2 is exposed from a bottom surface of the recessed portion 21, electrostatic attractive force is generated between the bottom surface of the recessed portion 21 and the movable body 32 due to charging of the bottom surface of the recessed portion 21 caused by a movement of the alkali metal ions contained in the substrate 2. Therefore, the movable body 32 may be swung due to the electrostatic attractive force, that is, the force other than the acceleration Az to be detected, and detection accuracy of the acceleration Az may decrease. Therefore, the dummy electrode 83 is provided in a region other than the first detection electrode 81 and second detection electrode 82 such that the surface of the substrate 2 is not exposed as much as possible in the bottom surface of the recessed portion 21. The dummy electrode 83 has the same potential as that of the sensor element 3, so that substantially no electrostatic attractive force acts between the dummy electrode 83 and the movable body 32.

When the first detection electrode 81 surrounds peripheries of the protrusions 23, 24, a potential difference is generated between the movable body 32 and the first detection electrode 81. In this case, when the movable body 32 sticks to the protrusions 23, 24, the sticking is less likely to be released due to electrostatic attractive force caused by the potential difference. Therefore, as described above, the dummy electrode 83 is provided in a region other than the first detection electrode 81 and second detection electrode 82 such that the surface of the substrate 2 is not exposed as much as possible in the bottom surface of the recessed portion 21. The dummy electrode 83 has the same potential as that of the sensor element 3, so that substantially no electrostatic attractive force acts between the dummy electrode 83 and the movable body 32.

Here, when the excessive acceleration Az which is an impact or the like is applied and the movable body 32 is swung excessively around the swing axis J, as illustrated in FIGS. 3 and 4, the first movable portion 321 contacts top surfaces 231, 241 of the protrusions 23, 24 before contacting the first detection electrode 81, so that further swinging is prevented. As a result, the contact between the movable body 32 and the first detection electrode 81 is prevented, so that a detection failure may be prevented. Excessive stress may be prevented from being applied to the beam 33, and the sensor element 3 may also be prevented from being broken. Pull-in of the movable body 32 may also be prevented by bringing the movable body 32 into contact with the protrusions 23, 24 before an electrostatic attractive force (a force that pulls the first movable portion 321 to the negative side in the Z axis direction) between the first movable portion 321 and the first detection electrode 81 becomes larger than a restoring force (a force that pulls the first movable portion 321 to the positive side in the Z axis direction) of the beam 33. Pull-in refers to a state in which a state of the first movable portion 321 being pulled to the first detection electrode 81 is maintained by the electrostatic attractive force between the first movable portion 321 and the first detection electrode 81.

The protrusions 23, 24 are configured to contact the distal end portion of the first movable portion 321. Therefore, the first detection electrode 81 may be provided without being disturbed by the protrusions 23, 24, and an area of the first detection electrode 81 may be allocated to be sufficiently large. As will be described below, it becomes easy to provide the dummy electrode 83 at the peripheries of the protrusions 23, 24. As illustrated in FIG. 5, the protrusions 23, 24 are arranged side by side in the Y axis direction and are spaced apart from each other. The protrusion 23 contacts a corner portion of the first movable portion 321 at the positive side of the first movable portion 321 in the Y axis direction, and the protrusion 24 contacts a corner portion of the first movable portion 321 at the negative side of the first movable portion 321 in the Y axis direction. Accordingly, the movable body 32 may be received in a well-balanced manner by the protrusions 23, 24, and a change ora deformation of a posture of the movable body 32 at a time of contact with the protrusions 23, 24 may be effectively prevented.

The electrodes 8 are not provided at surfaces of the protrusions 23, 24. That is, the top surfaces 231, 241 of the protrusions 23, 24 are exposed as the substrate 2 is exposed. Therefore, the top surfaces 231, 241 are directly in contact with the movable body 32. For example, as in the related art, if films are provided on the top surfaces 231, 241, the films may be peeled off at the time of contact with the movable body 32 and the peeled film may come into contact with or adhere to other parts, which may lead to a failure or a performance deterioration of the inertial sensor 1. On the other hand, as in the present embodiment, the above-described problem does not occur and high performance may be maintained over time by exposing the substrate 2 without providing films at the top surfaces 231, 241.

The top surfaces 231, 241 of the protrusions 23, 24 are exposed, so that the top surfaces 231, 241 may be charged due to a movement of the alkali metal ions contained in the substrate 2. Therefore, the movable body 32 may be unintentionally swung due to an electrostatic attractive force generated between the top surfaces 231, 241 and the movable body 32, and the movable body 32 may stick to the protrusions 23, 24. If the contact between the movable body 32 and the protrusions 23, 24 is repeated, the protrusions 23, 24 may also be charged. Therefore, the movable body 32 may also be unintentionally swung due to the electrostatic attractive force generated between the top surfaces 231, 241 and the movable body 32, and the movable body 32 may stick to the protrusions 23, 24. Therefore, in the inertial sensor 1, the entire peripheries of the protrusions 23, 24 are surrounded by the dummy electrode 83 having the same potential as that of the movable body 32. Accordingly, the protrusions 23, 24 are prevented from being charged, and the movable body 32 may be effectively prevented from being unintentionally swung as described above. The protrusions 23, 24 are prevented from being charged because the dummy electrode 83 is provided, so that the movable body 32 is prevented from sticking to the protrusions 23, 24. The dummy electrode 83 surrounds the peripheries of the protrusions 23, 24, so that the electrostatic attractive force that pulls the movable body 32 and the protrusions 23, 24 may be prevented, and the movable body 32 may be prevented from sticking to the protrusions 23, 24.

In particular, in the present embodiment, the dummy electrode 83 is provided between the protrusions 23, 24 and the first detection electrode 81, so that the electrostatic attractive force from the first detection electrode 81 may be prevented. The dummy electrode 83 is supplied with the same potential as that of the movable body 32, so that the dummy electrode 83 may be provided close to the protrusions 23, 24. Therefore, the above-described effects may be more remarkably attained. The dummy electrode 83 only need to surround at least a part of the peripheries of the protrusions 23, 24 in the plan view, and may have a configuration illustrated in FIG. 6, for example.

When high environmental resistance for vibration, impact, and the like is required for the inertial sensor 1, the protrusions 23, 24 may be provided at a first recessed portion 211. Accordingly, the movable body 32 may prevent the swing around the swing axis J at an early stage, and the sensor element 3 may be prevented from being broken. In this case, the entire peripheries of the protrusions 23, 24 are surrounded with a dummy electrode 83 extended from the dummy electrode 83. Accordingly, the protrusions 23, 24 are prevented from being charged, and the movable body 32 may be effectively prevented from being unintentionally swung as described above. The protrusions 23, 24 are prevented from being charged because the dummy electrode 83 is provided, so that the movable body 32 is prevented from sticking to the protrusions 23, 24.

As illustrated in FIG. 2, a distance D1 between the top surfaces 231, 241 of the protrusions 23, 24 and the movable body 32 is larger than a distance D2 between the first detection electrode 81 and the movable body 32. That is, D1>D2. Accordingly, the top surfaces 231, 241 and the movable body 32 may be sufficiently spaced apart from each other. Therefore, even if the protrusions 23, 24 are charged due to the above-described causes, the electrostatic attractive force generated between the protrusions 23, 24 and the movable body 32 may be sufficiently reduced. Therefore, the movable body 32 may be more effectively prevented from being unintentionally swung.

In particular, in the present embodiment, the top surfaces 231, 241 of the protrusions 23, 24 are flush with a bottom surface of the first recessed portion 211. In other words, the top surfaces 231, 241 are formed as a part of the bottom surface of the first recessed portion 211. Accordingly, formation of the protrusions 23, 24 becomes easy. However, heights of the protrusions 23, 24 are not particularly limited, and D1 may be equal to or less than D2. The top surfaces 231, 241 of the protrusions 23, 24 may be located above or below the bottom surface of the first recessed portion 211.

As described above, the protrusions 23, 24 are integral with the substrate 2. Therefore, the formation of the protrusions 23, 24 becomes easy. Toughness of the protrusions 23, 24 may be improved, and the protrusions 23, 24 may be effectively prevented from being broken. However, the protrusions 23, 24 may be formed separately from the substrate 2 and bonded to the substrate 2 by an adhesive or the like.

A forming material of the protrusions 23, 24 is a glass material, and Young's modulus thereof is approximately 80 GPa. On the other hand, a forming material of the movable body 32 is silicon, and Young's modulus thereof is approximately 185 GPa. That is, the Young's modulus of the forming material of the protrusions 23, 24 is smaller than the Young's modulus of the forming material of the movable body 32. Therefore, the protrusions 23, 24 may be softened with respect to the movable body 32, so that an impact at the time of the contact may be alleviated, and the movable body 32 may be prevented from being broken. However, the Young's modulus of the forming material of the protrusions 23, 24 is not limited thereto, and may be equal to or larger than the Young's modulus of the forming material of the movable body 32. Various conditions which are shapes, dimensions, arrangement, the number of formed protrusions, forming materials, and the like of the protrusions 23, 24 are not limited to those described above. For example, a shape of the protrusions 23, 24 in the plan view may be a longitudinal shape extending in the X axis direction or the Y axis direction.

Returning to the description of the movable body 32, as illustrated in FIGS. 3 and 4, the first movable portion 321 is formed with two through holes 326, 327 penetrating the first movable portion 321 in the thickness direction thereof. The through hole 326 overlaps with the protrusion 23 in the plan view, and the through hole 327 overlaps with the protrusion 24 in the plan view. A width W1 of lower side openings of the through holes 326, 327 is smaller than a width W2 of the top surfaces 231, 241 of the protrusions 23, 24. That is, W1<W2. With this relationship, central portions of the top surfaces 231, 241 overlap the through holes 326, 327 in the plan view, and outer edge portions of the top surfaces 231, 241 overlap a lower surface of the first movable portion 321. Therefore, the protrusions 23, 24 and the movable body 32 may be brought into contact with each other with a small area without lowering the toughness of the protrusions 23, 24. As a result, the protrusions 23, 24 and the movable body 32 may be more effectively prevented from sticking to each other.

In the present embodiment, the through holes 326, 327 have a circular shape, so that the width W1 is equal to a diameter thereof. Similarly, in the present embodiment, the top surfaces 231, 241 have a circular shape, so that the width W2 is equal to a diameter thereof. However, the shape of the through holes 326, 327 is not limited to a circular shape, and may be, for example, an elliptical shape, an oval shape, a triangular shape, a quadrangular shape, a polygonal shape having five or more sides, or an irregular shape. Similarly, the shape of the top surfaces 231, 241 is not limited to a circular shape, and may be, for example, an elliptical shape, an oval shape, a triangular shape, a quadrangular shape, a polygonal shape having five or more sides, or an irregular shape. The shapes of the through holes 326, 327 and the top surfaces 231, 241 may be different from each other.

The inertial sensor 1 has been described above. As described above, the inertial sensor 1 includes: the substrate 2; the movable body 32 that includes the first movable portion 321 and the second movable portion 322 sandwiching the swing axis J and having different rotation moments around the swing axis J and that is swung around the swing axis J with respect to the substrate 2; the first detection electrode 81 that is the detection electrode that is provided at the substrate 2 and that overlaps with the first movable portion 321 in the plan view; the dummy electrode 83 that is provided on the substrate 2, that overlaps with the first movable portion 321 in the plan view, and that has the same potential as that of the movable body 32; and the protrusions 23, 24 that are provided on the substrate 2, that overlap with the first movable portion 321 in the plan view, that protrude toward the movable body 32, and that prevent the movable body 32 from being displaced around the swing axis J. The dummy electrode 83 is located between the protrusions 23, 24 and the first detection electrode 81, and surrounds at least a part of the peripheries of the protrusions 23, 24, in the present embodiment, the entire peripheries. The top surfaces 231, 241, which are contact portions of the protrusions 23, 24 with the movable body 32, are formed of an insulating material, in the present embodiment, the glass material.

According to this configuration, the protrusions 23, 24 are prevented from being charged because the dummy electrode 83 is provided, so that the electrostatic attractive force is prevented from being generated between the protrusions 23, 24 and the movable body 32. The protrusions 23, 24 are prevented from being charged because the dummy electrode 83, so that the movable body 32 is prevented from sticking to the protrusions 23, 24. The dummy electrode 83 surrounds the peripheries of the protrusions 23, 24, so that the electrostatic attractive force that pulls the movable body 32 and the protrusions 23, 24 may be prevented, and the movable body 32 may be prevented from sticking to the protrusions 23, 24. Therefore, the movable body 32 is prevented from being swung due to a force other than the acceleration Az to be detected, and the detection accuracy of the acceleration Az is improved.

As described above, the substrate 2 includes the first recessed portion 211 that opens to the upper surface of the substrate 2 which is a main surface facing the movable body 32, and a second recessed portion 212 that opens to the bottom surface of the first recessed portion 211. In other words, the substrate 2 includes a recessed portion that opens to the movable body 32, and the recessed portion includes the first recessed portion 211 and the second recessed portion 212 deeper than the first recessed portion 211. The first detection electrode 81 is provided at the bottom surface of the first recessed portion 211, the dummy electrode 83 is provided at the bottom surface of the second recessed portion 212, and the protrusions 23, 24 protrude from the bottom surface of the second recessed portion 212. Accordingly, a configuration of the substrate 2 is simplified.

As described above, the distance D1 between the movable body 32 and the protrusions 23, 24 is larger than the distance D2 between the movable body 32 and the first detection electrode 81. That is, D1>D2. Accordingly, the protrusions 23, 24 and the movable body 32 may be sufficiently spaced apart from each other. Therefore, even if the protrusions 23, 24 are charged, the electrostatic attractive force generated between the protrusions 23, 24 and the movable body 32 may be sufficiently reduced. Therefore, the movable body 32 may be more effectively prevented from being unintentionally swung.

As described above, the protrusions 23, 24 are integral with the substrate 2. Accordingly, the formation of the protrusions 23, 24 becomes easy. The toughness of the protrusions 23, 24 may be improved, and the protrusions 23, 24 may be effectively prevented from being broken.

As described above, the forming material of the protrusions 23, 24 and the substrate 2 is glass. Accordingly, it becomes easy to form the protrusions 23, 24 integrally with the substrate 2.

As described above, the Young's modulus of the forming material of the protrusions 23, 24 is smaller than the Young's modulus of the forming material of the movable body 32. Accordingly, the protrusions 23, 24 may be sufficiently softened with respect to the movable body 32. Therefore, the movable body 32 may be effectively prevented from being broken due to the contact with the protrusions 23, 24.

### Second Embodiment

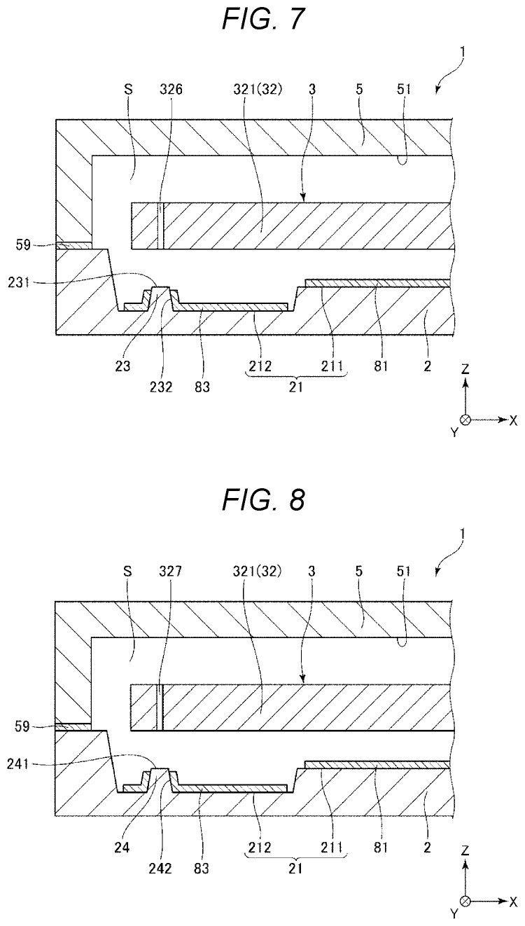

FIGS. 7 and 8 are cross-sectional views illustrating an inertial sensor according to the second embodiment.

The present embodiment is the same as the above-described first embodiment except that an arrangement of the dummy electrode 83 is different. In the following description, the present embodiment will be described with a focus on the difference from the above-described embodiment, and a description of similar matters will be omitted. In FIGS. 7 and 8, the same reference numerals are given to configurations similar to those according to the above-described embodiment. FIG. 7 corresponds to a cross section taken along the line B-B in FIG. 1, and FIG. 8 corresponds to a cross section taken along the line C-C in FIG. 1.

As illustrated in FIGS. 7 and 8, the dummy electrode 83 is also provided at side surfaces 232, 242 of the protrusions 23, 24. That is, the dummy electrode 83 is also provided at regions other than the top surfaces 231, 241 which are the contact portions of the protrusions 23, 24 with the movable body 32. Accordingly, the protrusions 23, 24 may be more effectively prevented from being charged because the dummy electrode 83 is provided also at the protrusions 23, 24.

Accordingly, in the inertial sensor 1 according to the present embodiment, the dummy electrode 83 is also provided at the side surfaces 232, 242 that are not the top surfaces 231, 241 serving as the contact portions of the protrusions 23, 24. Accordingly, the protrusions 23, 24 may be more effectively prevented from being charged.

### Third Embodiment

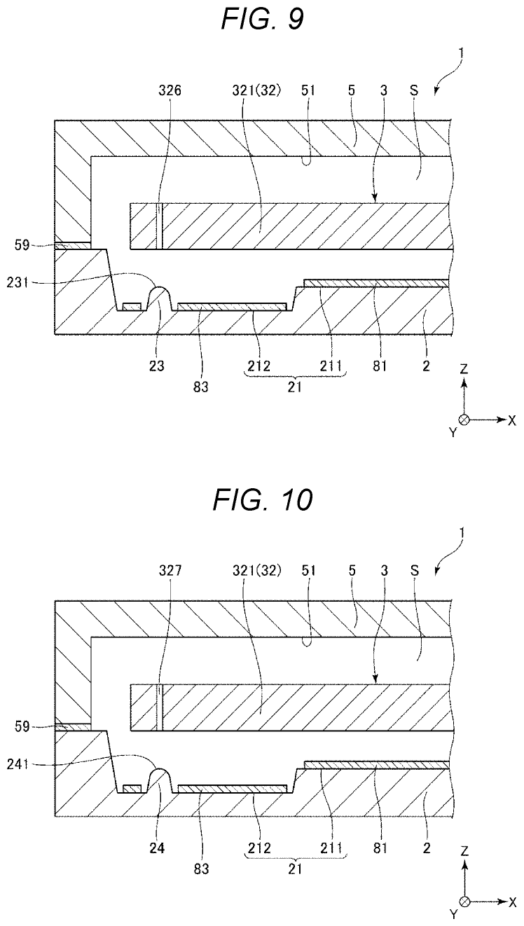

FIGS. 9 and 10 are cross-sectional views illustrating an inertial sensor according to the third embodiment.

The present embodiment is the same as the above-described first embodiment except that configurations of the protrusions 23, 24 are different. In the following description, the present embodiment will be described with a focus on the difference from the above-described embodiments, and a description of similar matters will be omitted. In FIGS. and 10, the same reference numerals are given to configurations similar to those according to the above-described embodiments. FIG. 9 corresponds to the cross section taken along the line B-B in FIG. 1, and FIG. 10 corresponds to the cross section taken along the line C-C in FIG. 1.

As illustrated in FIGS. 9 and 10, the top surfaces 231, 241 of the protrusions 23, 24 are rounded, and are curved surfaces, specifically, curved convex surfaces. Accordingly, for example, as compared with the above-described first embodiment, a contact area between the top surfaces 231, 241 and the movable body 32 is reduced, so that the protrusions 23, 24 and the movable body 32 may be more effectively prevented from sticking to each other.

Accordingly, in the inertial sensor 1 according to the present embodiment, the top surfaces 231, 241 that are the contact portions are rounded. Accordingly, for example, as compared with the above-described first embodiment, the contact area between the top surfaces 231, 241 and the movable body 32 is reduced, so that the protrusions 23, 24 and the movable body 32 may be more effectively prevented from sticking to each other.

### Fourth Embodiment

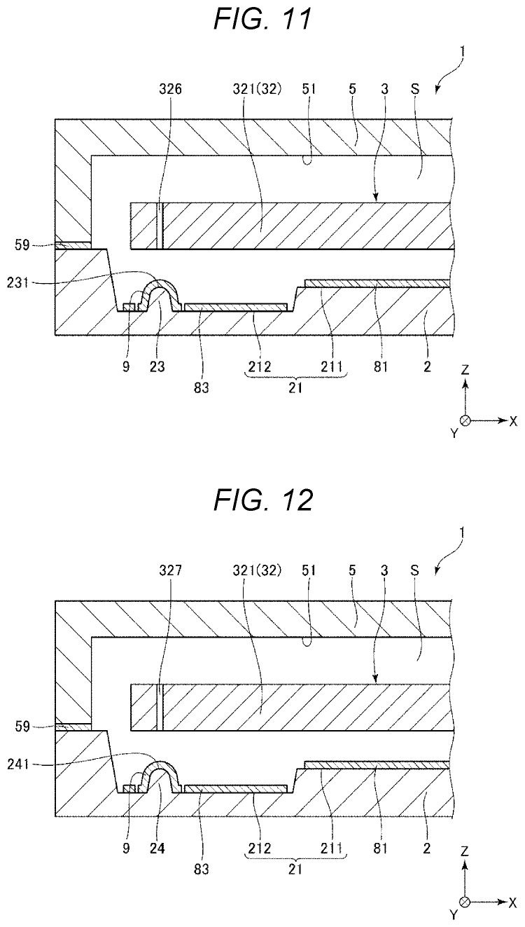

FIGS. 11 and 12 are cross-sectional views illustrating an inertial sensor according to the fourth embodiment.

The present embodiment is the same as the above-described third embodiment except that the configurations of the protrusions 23, 24 are different. In the following description, the present embodiment will be described with a focus on the difference from the above-described embodiments, and a description of similar matters will be omitted. In FIGS. 11 and 12, the same reference numerals are given to configurations similar to those according to the above-described embodiments. FIG. 11 corresponds to the cross section taken along the line B-B in FIG. 1, and FIG. 12 corresponds to the cross section taken along the line C-C in FIG. 1.

As illustrated in FIGS. 11 and 12, the inertial sensor 1 includes insulating films 9 that cover the surfaces of the protrusions 23, 24. Accordingly, the alkali metal ions contained in the substrate 2 may be prevented from being exposed to the surface thereof, and the electrostatic attractive force may be effectively prevented from being generated between the protrusions 23, 24 and the movable body 32. The insulating films 9 are not particularly limited, and may be formed of, for example, silicon oxide or silicon nitride.

### Fifth Embodiment

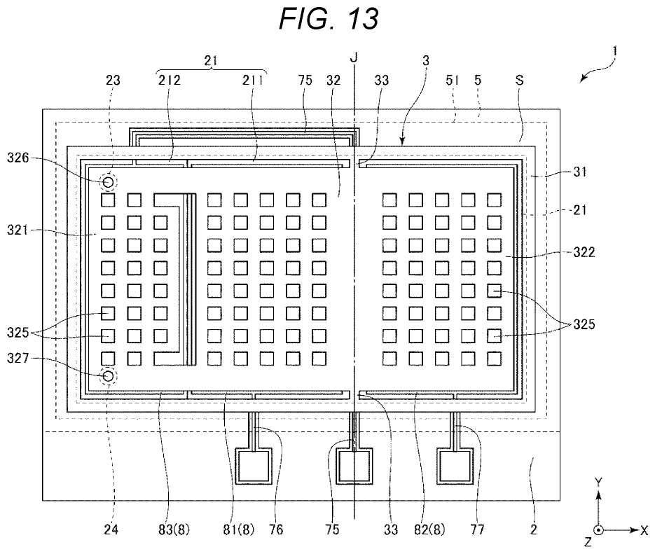

FIG. 13 is a plan view illustrating an inertial sensor according to the fifth embodiment.

The present embodiment is the same as the above-described first embodiment except that a configuration of the sensor element 3 is different. In the following description, the present embodiment will be described with a focus on the difference from the above-described embodiments, and a description of similar matters will be omitted. In FIG. 13, the same reference numerals are given to configurations similar to those according to the above-described embodiments.

As illustrated in FIG. 13, in the sensor element 3 according to the present embodiment, the fixed portion 31 is located outside the movable body 32, and has a frame shape surrounding the movable body 32. The fixed portion 31 is anodically bonded to the upper surface of the substrate 2. Accordingly, the fixed portion 31 is bonded to the upper surface of the substrate 2, so that the mount 22 is omitted from the substrate 2. The beam 33 is located between the fixed portion 31 and the movable body 32.

### Sixth Embodiment

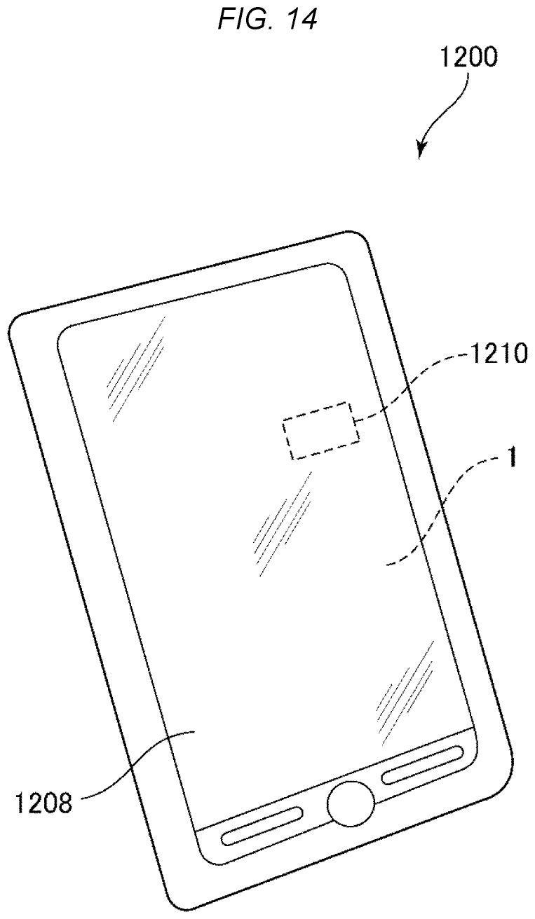

FIG. 14 is a plan view illustrating a smartphone according to the sixth embodiment.

A smartphone 1200 that is an electronic device illustrated in FIG. 14 includes the inertial sensor 1 and a control circuit 1210 that performs control based on a detection signal output from the inertial sensor 1. Detection data obtained by detection of the inertial sensor 1 is transmitted to the control circuit 1210. The control circuit 1210 may recognize a posture and operation of the smartphone 1200 from the received detection data, and may change a display image displayed at the display unit 1208, sound a warning sound or a sound effect, or drive a vibration motor to vibrate a body of the smartphone 1200.

The smartphone 1200 that is the electronic device includes the inertial sensor 1 and the control circuit 1210 that performs control based on the detection signal output from the inertial sensor 1. Therefore, the smartphone may attain the above-described effect of the inertial sensor 1, and may have high reliability.

In addition to the above-described smartphone 1200, the electronic device may be, for example, a personal computer, a digital still camera, a tablet terminal, a watch, a smart watch, an ink jet printer, a laptop personal computer, a television, a wearable terminal that is a head-mounted display (HMD) or the like, a video camera, a video tape recorder, a car navigation device, a pager, an electronic notebook, an electronic dictionary, a calculator, an electronic game device, a word processor, a workstation, a video phone, a surveillance television monitor, an electronic binocular, a POS terminal, a medical device, a fish finder, various measurement devices, a device for mobile terminal base station, various instruments of a vehicle, an aircraft, a ship, and the like, a flight simulator, a network server, or the like.

### Seventh Embodiment

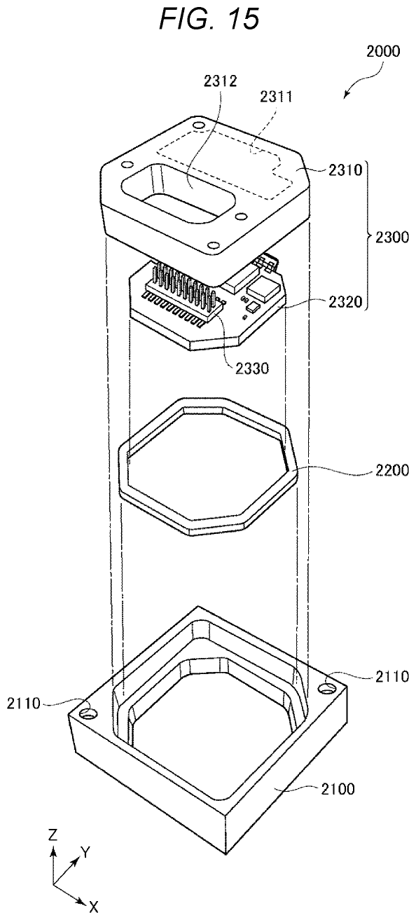

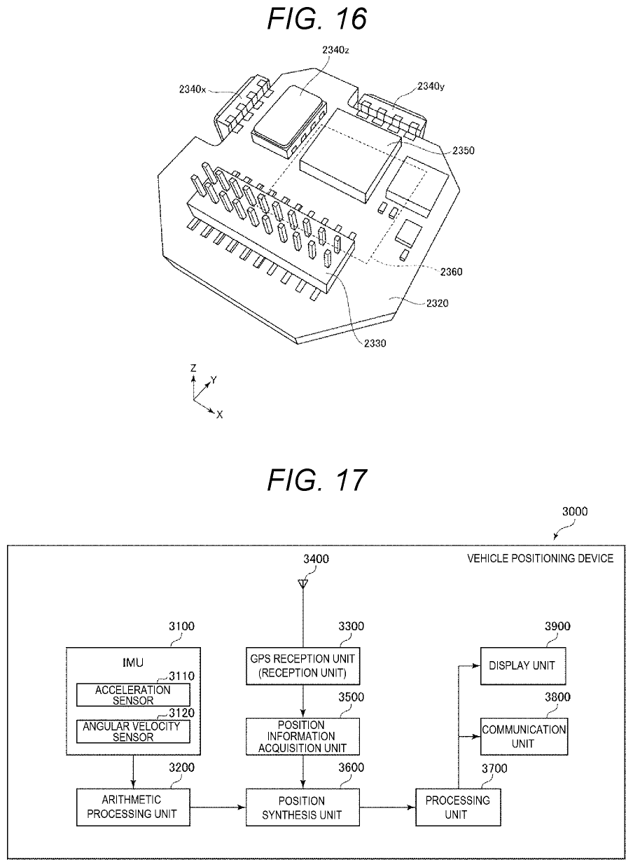

FIG. 15 is an exploded perspective view illustrating an inertial measurement device according to the seventh embodiment. FIG. 16 is a perspective view of a substrate provided in the inertial measurement device illustrated in FIG. 15.

An inertial measurement device 2000 (IMU) that is an electronic device illustrated in FIG. 15 detects a posture or operation of a mounting device that is an automobile, a robot, or the like. The inertial measurement device 2000 functions as a six-axis motion sensor including a three-axis acceleration sensor and a three-axis angular velocity sensor.

The inertial measurement device 2000 is a rectangular parallelepiped having a substantially square planar shape. Screw holes 2110 that are fixed portions are formed near two vertexes located at the square in a diagonal direction of the square. The inertial measurement device 2000 may be fixed to a mounting surface of a mounting body of an automobile or the like through two screws in the two screw holes 2110. A size of the inertial measurement device 2000 may be reduced to a size in which the inertial measurement device 2000 may be mounted in, for example, a smartphone or a digital still camera by selecting a component or changing a design.

The inertial measurement device 2000 includes an outer case 2100, a bonding member 2200, and a sensor module 2300, and the sensor module 2300 is inserted into the outer case 2100 with a bonding member 2200 interposed therebetween. An outer shape of the outer case 2100 is a rectangular parallelepiped having a substantially square planar shape, similar to an overall shape of the above-described inertial measurement device 2000, and the screw holes 2110 are formed near the two vertexes located at the square in the diagonal direction of the square. The outer case 2100 has a box shape, and the sensor module 2300 is housed inside the outer case 2100.

The sensor module 2300 includes an inner case 2310 and a substrate 2320. The inner case 2310 supports the substrate 2320, and has a shape that fits inside the outer case 2100. The inner case 2310 is formed with a recessed portion 2311 that prevents contact with the substrate 2320 and an opening 2312 through which a connector 2330 (described below) is exposed. The inner case 2310 is bonded to the outer case 2100 via the bonding member 2200. The substrate 2320 is bonded to a lower surface of the inner case 2310 via an adhesive.

As illustrated in FIG. 16, the connector 2330, an angular velocity sensor 2340z that detects an angular velocity around the Z axis, an acceleration sensor 2350 that detects acceleration in the X axis direction, the Y axis direction, and the Z axis direction, and the like are mounted at an upper surface of the substrate 2320. An angular velocity sensor 2340x that detects an angular velocity around the X axis and an angular velocity sensor 2340y that detects an angular velocity around the Y axis are mounted at a side surface of the substrate 2320. The inertial sensor according to the present disclosure may be used as the acceleration sensor 2350.

A control IC 2360 is mounted at a lower surface of the substrate 2320. The control IC 2360 is a micro controller unit (MCU) and controls each unit of the inertial measurement device 2000. A storage unit stores a program that defines an order and a content for detection of the acceleration and the angular velocity, a program that digitizes detection data and incorporates the detection data into packet data, accompanying data, and the like. A plurality of electronic components are mounted at the substrate 2320.

### Eighth Embodiment

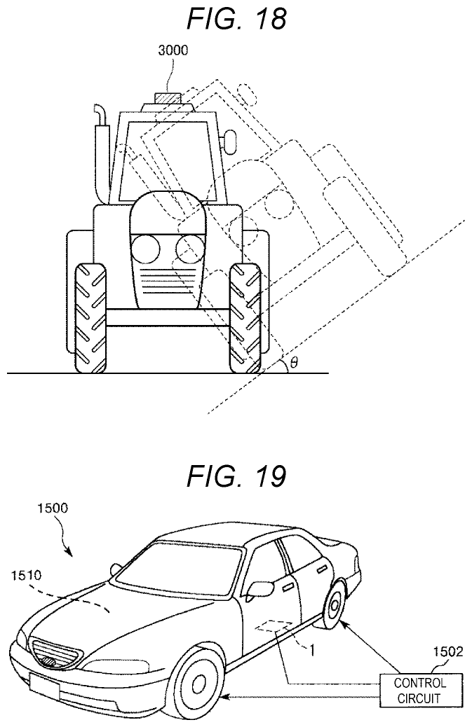

FIG. 17 is a block diagram showing an entire system of a vehicle positioning device according to the eighth embodiment. FIG. 18 illustrates operation of the vehicle positioning device shown in FIG. 17.

A vehicle positioning device 3000 shown in FIG. 17 is used by being mounted to a vehicle and positions the vehicle. The vehicle is not particularly limited, and may be any of a bicycle, an automobile, a motorcycle, a train, an airplane, a ship, or the like, and in the present embodiment, a case in which a four-wheeled vehicle is used as the vehicle will be described.

The vehicle positioning device 3000 includes an inertial measurement device 3100 (IMU), an arithmetic processing unit 3200, a GPS reception unit 3300, a reception antenna 3400, a position information acquisition unit 3500, a position synthesis unit 3600, a processing unit 3700, a communication unit 3800, and a display unit 3900. The above-described inertial measurement device 2000, for example, may be used as the inertial measurement device 3100.

The inertial measurement device 3100 includes a three-axis acceleration sensor 3110 and a three-axis angular velocity sensor 3120. The arithmetic processing unit 3200 receives acceleration data from the acceleration sensor 3110 and angular velocity data from the angular velocity sensor 3120, performs inertial navigation arithmetic processing on the data, and outputs inertial navigation positioning data including acceleration and a posture of the vehicle.

The GPS reception unit 3300 receives a signal from a GPS satellite via the reception antenna 3400. The position information acquisition unit 3500 outputs GPS positioning data indicating a position (a latitude, a longitude, and an altitude), a speed, and orientation of the vehicle positioning device 3000 based on the signal received by the GPS reception unit 3300. The GPS positioning data also includes status data indicating a reception state, a reception time, and the like.

The position synthesis unit 3600 calculates a position of the vehicle, specifically, a position of the vehicle on the ground based on the inertial navigation positioning data output from the arithmetic processing unit 3200 and the GPS positioning data output from the position information acquisition unit 3500. For example, even if the position of the vehicle in the GPS positioning data is the same, as illustrated in FIG. 18, the vehicle is travelling at a different position on the ground if the posture of the vehicle is different due to an influence of a ground inclination 8 or the like. Therefore, an accurate position of the vehicle may not be calculated only by the GPS positioning data. Therefore, the position synthesis unit 3600 uses the inertial navigation positioning data to calculate which position of the ground the vehicle is traveling.

Position data output from the position synthesis unit 3600 is subjected to predetermined processing by the processing unit 3700, and is displayed on the display unit 3900 as a positioning result. The position data may be transmitted to an external device by the communication unit 3800.

### Ninth Embodiment

FIG. 19 is a perspective view illustrating a vehicle according to the ninth embodiment.

An automobile 1500 that is a vehicle illustrated in FIG. 19 includes a system 1510 that is at least one of an engine system, a brake system or a keyless entry system, the inertial sensor 1, and a control circuit 1502, and may detect a posture of an automobile body by the inertial sensor 1. A detection signal of the inertial sensor 1 is supplied to the control circuit 1502, and the control circuit 1502 may control the system 1510 based on the signal.

As described above, the automobile 1500 that is the vehicle includes the inertial sensor 1 and the control circuit 1502 that performs control based on the detection signal output from the inertial sensor 1. Therefore, the automobile 1500 may attain the above-described effect of the inertial sensor 1, and may have high reliability.

In addition, the inertial sensor 1 may be widely applied to a car navigation system, a car air conditioner, an anti-lock brake system (ABS), an airbag, a tire pressure monitoring system (TPMS), an engine control, an electronic control unit (ECU) of a battery monitor for a hybrid vehicle or an electric vehicle or the like. The vehicle is not limited to the automobile 1500, and may be applied to, for example, an airplane, a rocket, an artificial satellite, a ship, an automatic guided vehicle (AGV), a bipedal walking robot, and an unmanned airplane such as a drone.

The inertial sensor, the electronic device, and the vehicle according to the present disclosure have been described above based on the embodiments with reference to the drawings. However, the present disclosure is not limited thereto, and a configuration of each unit may be replaced with any configuration having the same function. Any other component may be added to the present disclosure. The above-described embodiments may be combined as appropriate.

What is claimed is:

1. An inertial sensor comprising:
a substrate;
a movable body that includes a first movable portion and a second movable portion sandwiching a swing axis and having different rotation moments around the swing axis and that is swung around the swing axis with respect to the substrate;
a detection electrode that is provided at the substrate and that overlaps with the first movable portion in a plan view;
a dummy electrode that is provided on the substrate, that overlaps with the first movable portion in the plan view, and that has the same potential as that of the movable body; and
a protrusion that is provided on the substrate, that overlaps with the first movable portion in the plan view, that protrudes toward the movable body, and that prevents the movable body from being displaced around the swing axis, wherein
the dummy electrode is located between the protrusion and the detection electrode, and surrounds at least a part of a periphery of the protrusion, and
a contact portion of the protrusion with the movable body is formed of an insulating material.

2. The inertial sensor according to claim 1, wherein
the substrate includes a recessed portion opening toward the movable body,
the recessed portion includes a first recessed portion and a second recessed portion deeper than the first recessed portion,
the detection electrode is provided at a bottom surface of the first recessed portion,
the dummy electrode is provided at a bottom surface of the second recessed portion, and
the protrusion protrudes from the bottom surface of the second recessed portion.

3. The inertial sensor according to claim 1, wherein
the dummy electrode is also provided in a region other than the contact portion of the protrusion.

4. The inertial sensor according to claim 1, wherein
a distance between the movable body and the protrusion is larger than a distance between the movable body and the detection electrode.

5. The inertial sensor according to claim 1, wherein
the contact portion is rounded.

6. The inertial sensor according to claim 1, wherein
the protrusion is integral with the substrate.

7. The inertial sensor according to claim 6, wherein
a forming material of the protrusion and the substrate is glass.

8. The inertial sensor according to claim 1, wherein
a Young's modulus of a forming material of the protrusion is smaller than a Young's modulus of a forming material of the movable body.

9. An electronic device comprising:
the inertial sensor according to claim 1; and
a control circuit that performs control based on a detection signal output from the inertial sensor.

10. A vehicle comprising:
the inertial sensor according to claim 1; and
a control circuit that performs control based on a detection signal output from the inertial sensor.
